(19) United States
(12) Patent Application Publication
(10) Pub. No.: US 2019/0268173 A1
(43) Pub. Date: Aug. 29, 2019

(54) Virtual World Processing System and Method Thereof

(71) Applicant: Suraj Shakthi Sarja, Bangalore (IN)

(72) Inventor: Suraj Shakthi Sarja, Bangalore (IN)

(21) Appl. No.: 16/272,193

(22) Filed: Feb. 11, 2019

(51) Int. Cl. H04L 12/18; G06F 3/14

(52) U.S. Cl. CPC H04L 12/1822; G06F 3/14

(57) ABSTRACT

A system and method for providing a user to be present at multiple locations with different characteristics while being at one physical location comprising: providing a user an operable display (107) on the handheld wireless device; allowing the user to selectively operate the hand-held wireless device by login; teleporting the user to be virtually present at multiple locations in a virtual world by virtual teleportation while being present at one physical location; enabling the user to communicate with multiple users nearby or worldwide when teleported with one or more characteristics at the same time; providing scores to the users based on color codes for character detection by score detect module (112); analyzing the scores by a anlayzer module (113), and providing users an upper hand before starting the communication.

### FIELD OF THE INVENTION

The present invention relates to a virtual environment and, more particularly, relates to connecting people in a virtual world in real-time.

### BACKGROUND

A virtual environment is an interactive environment for communicating between people all around the world. In a conventional method, presenting chat groups at wireless mobile terminals where the invention displays a chat conversation between multiple users. Some of the methods are directed to teleporting avatars between disparate virtual worlds. A system facilitating personal profiles to and from disparate world's example rendering information, trait information, and inventory information.

Conventional methods presenting chat sessions between multiple users in real time has been current trends for this particular environment. Here a user can chat by sitting in his room and can connect to multiple users to the chat session through his wireless device in this virtual world environment.

There is a need for a system and method for teleporting a user for communication with multiple users in real time.

### OBJECT OF THE INVENTION

The object of the present invention is to provide a virtual world networking communication system using teleporting.

One another object of the present invention is to provide a virtual world networking system where a user can be at multiple locations with different characteristics at the same time by virtue of Virtual Teleport.

### SUMMARY OF THE INVENTION

The present invention provides a method and system for connecting people for real time communications in a virtual reality environment. The method for connecting people nearby user area or anywhere in the world using one of the unique feature “Virtual teleport” (VTP). The method of the present invention provides a user to be present at multiple locations with different characteristics at the same time by virtue of the virtual teleport.

The system further includes a processing system comprises a memory, a teleport system coupled to the memory, and one or more modules. The modules include an analyzer module and a score provider module. Further, the analyzer module is configured analyze and provide the score, based on color codes, to different members. The identification module is configured to identify position and identification of the one or more passive optical identifier tag from the plurality of passive optical

A first aspect of the present invention provides connecting a user in the virtual world for real-time communications, thus allowing the user to be present in multiple locations in said virtual world for communication or for chatting purpose.

A second aspect of the present invention is directed to a method for teleporting in the virtual world with different characteristics, the said to be provided on an operable hand-held wireless device.

A third aspect of the present invention is directed to a method for teleporting a user to be present in multiple locations, said location to be changed by providing an option to user “change Location” to change but not limited to the area, venue/hangout places, city & country.

A fourth aspect of the present invention is directed to a method for a teleporting a user to be present at multiple locations at the same time with different characteristics. The characteristics involve but not limited to scores based customized character detection, search characteristics, Newsroom characteristics, trending now characteristics, editor's choice characteristic, a refreshing corner, an emergency services characteristics, messenger characteristics, an invite mode, calling option characteristics, and business section.

The User has to register, get a login and start talking to people nearby the user in his area and also anywhere in the world using the unique features VTP. The character detection characteristics of the present invention provide a customized character detection system. This customized character detection is a score based detection system. Score increases or decreases based on user interactions with other members every time chat sessions are closed. Members are separately color coded and changed accordingly based on the interaction with other users. Colour codes are awarded to all the users based on their score & interactions, and this will change accordingly over a period of time. This is combined with the character detection system providing the user always an upper hand before starting a conversation.

The present disclosure includes method and system which perform these methods, including processing systems which perform these methods, and computer readable media which when executed on processing systems cause the systems to perform these methods.

In one of the embodiments of the present invention is directed to a method for teleporting of the user to be present at multiple locations with different characteristics. The said characteristics have one or more features that are displayed on the operable display of the hand-held wireless device. Search option as one of the features, where a user can search by profile or search by profession, nativity, interest or search by contacts. Talent pool feature is provided where the members get to upload their work for free and the admins will select the top 5 best works for the day and place it in the trending/editor's choice category. A newsroom feature where the paid articles related to politics, education, entertainment & sports are provided. In one of the embodiments trending now feature is provided where the admins handpick the most trending topics and place them on the virtual networking app. There is Editors choice where a mixture of all news is covered from all of the categories under differ rent related sections.

A refresh corner feature is provided which is one stop solution for all like-minded users. There will be chat rooms based on different categories so that the members can decide by their choice of liking.

A contact manager feature dedicated gallery for the users to upload photos and videos which are seen by those users who are in the contact list.

Search by features a unique feature enables the users to search people who are on contacts list if they are in the vicinity of a predefined range of 1500 Metres. It also sends the notifications to the user if any of the User's contact is in the vicinity of a predefined range of 1500 Metres in real time. The user can know exactly where the other user is in the vicinity of a the predefined range of 1500 Metres

In the present invention, an emergency service feature is provided. A messenger feature which allows users to send messages to members using the said virtual networking application is provided. There an invite mode is provided where the said invite mode is visible in the chat messenger window. A calling option which is based on users permission is provided to the user, so as to call other users.

A business section option is provided in the virtual networking application of the present invention. The business section includes human resources category where resume upload, live screening of the candidate resume & discussion only with mutual consent, an instant short listing of candidates is provided. This reduces the time by more than half for hiring by removing multiple layers of entities and activities between employers and employees. Also, it finds most suitable candidates for a particular job position and hence reduces the dependency on HR firms.

### BRIEF DESCRIPTION OF THE DRAWINGS

FIG. 1 illustrates an exemplary block diagram 100 depicting a virtual world processing system, according to an exemplary implementation of the present invention.

FIG. 2 illustrates an example flowchart, according to an exemplary implementation of the present invention.

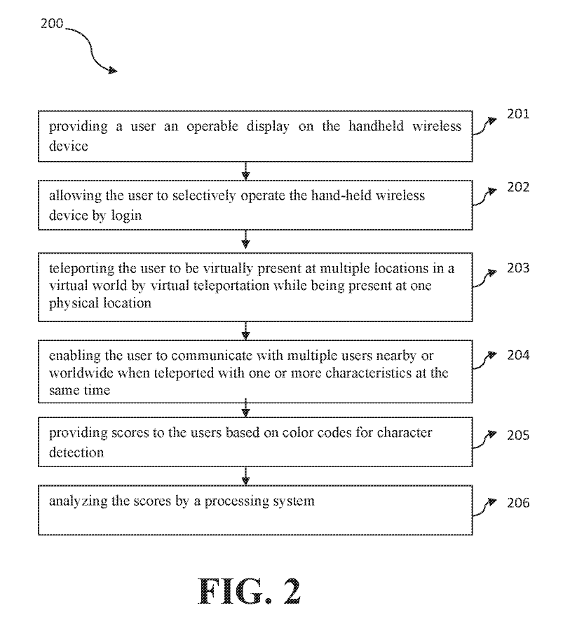

### DETAILED DESCRIPTION

In the following description, for purposes of explanation, numerous specific details are set forth in order to provide a thorough understanding of the description. It will be apparent, however, to one skilled in the art that embodiments of the disclosure can be practiced without these specific details.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In an implementation, the claimed subject matter of the present invention discloses a computer-implemented system for connecting plurality of users in real time communications, in a virtual reality environment. The system for connecting people nearby user area or anywhere in the world using one of the unique feature “Virtual teleport” (VTP). The system of the present invention provides a user to be present at multiple locations with different characteristics at the same time by virtue of the VTP. The virtual world processing system comprising: a server to host a virtual reality world; a data processing system to perform a teleporting with different characteristics; an operable hand-held display to log in, wirelessly connected to the server through a network; a memory; an analyzer unit to analyze color codes based on scores, and teleporting system for users to be present at multiple locations with different characteristics.

In an implementation, the claimed subject matter of the present invention discloses a computer-implemented method for connecting plurality of users in real time communications, in a virtual reality environment. The method for connecting people nearby user area or anywhere in the world using one of the unique feature “Virtual teleport” (VTP). The method of the present invention provides a user to be present at multiple locations with different characteristics at the same time by virtue of the VTP. The method involves steps of providing a user an operable display on the handheld wireless device; allowing the user to selectively operate the hand-held wireless device by login; teleporting the user to be virtually present at multiple locations in virtual world by virtual teleportation; enabling the user to communicate with multiple users nearby or worldwide when teleported with one or more characteristics at the same time; providing scores to the users based on color codes for character detection; analyzing the scores by a processing system, and providing users an upper hand before starting the communication.

In an implementation, the claimed subject matter of the present invention discloses a computer-implemented method for connecting plurality of users in real time communications, in a virtual reality environment. The method includes: providing an option to user “change Location” to change but not limited to the area, venue/hangout places, city & country. The User has to register, get a login and start talking to people nearby the user in his area and also anywhere in the world using the unique features VTP.

In an implementation, the claimed subject matter of the present invention discloses a computer-implemented method for connecting plurality of users in real time communications, in a virtual reality environment. The method of customized character detection, is a score based detection system. Score increases or decreases based on user interactions with other members every time chat sessions are closed. Members are separately color coded and changed accordingly based on the interaction with other users. Colour codes are awarded to all the users based on their score & interactions, and this will change accordingly over a period of time. This is combined with the character detection system. This provides the users always an upper hand before starting a conversation.

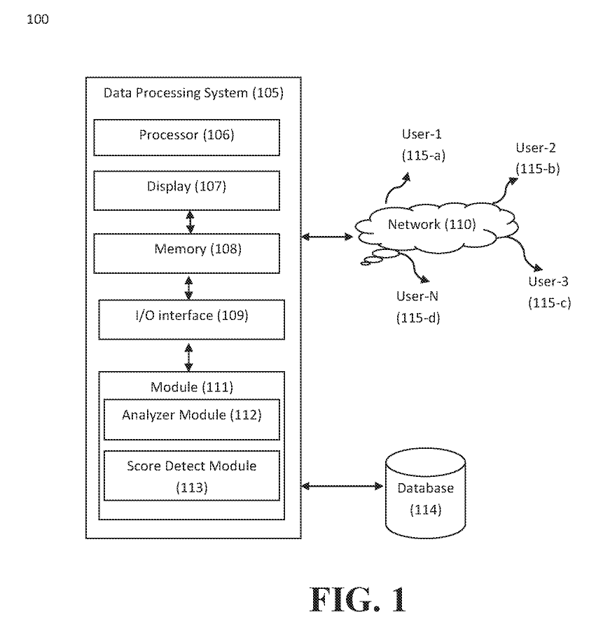

FIG. 1 illustrates an exemplary block diagram 100 depicting a virtual world processing system, according to an exemplary implementation of the present invention. The block diagram (100) is typically implemented in a computing environment. The block diagram (100) includes a processing system (105), a display (107), a memory (108), an I/O interface (109), a module (111), database (114), a network (110), a plurality of users using computing devices 115 (115-a, 115-b, 115-c, 115-d), and a database (114). The network (110) interconnects the computing devices (115) and the database (114) with the processing system (105). The network (115) includes wired and wireless networks. Examples of the wired networks include a wide area network (WAN) or a local area network (LAN), a client-server network, a peer-to peer network, and so forth. Examples of the wireless networks include Wi-Fi, a global system for mobile communications (GSM) network, a general packet radio service (GPRS) network, an enhanced data GSM environment (EDGE) network, 10 802.5 communication networks, code division multiple access (CDMA) networks, or Bluetooth networks. In the present implementation, the database (114) may be implemented as an enterprise database, a remote database, local database, and the like. The database (114) may be located within the vicinity of the processing system (105) or may be located at different geographic locations as compared to that of the processing system (105). Further, the database (114) may themselves be located either within the vicinity of each other or may be located at different geographic locations. Furthermore, the database (114) may be implemented inside the processing system (105) or the database (114) may be implemented as a single database or a separate unit. In the present implementation, the processing system (105) includes one or more processors (106). The processor (106) may be implemented as one or more microprocessors, microcomputers, microcontrollers, digital signal processors, central processing units, state machines, logic circuitries, and/or any devices that manipulate signals based on operational instructions. Among other capabilities, at least one processor (106) is configured to fetch and execute computer-readable instructions stored in the memory (108). The I/O interface (109) may include a variety of software and hardware interfaces, for example, a web interface, a graphical user interface, and the like. The I/O interface (109) may allow the processing system (105) to interact with a user directly or through the user computing devices (115). Further, the I/O interface (109) may enable the processing system (105) to communicate with other user devices or computing devices (115), such as web servers and external data servers (not shown). The I/O interface (109) can facilitate multiple communications within a wide variety of networks and protocol types, including wired networks, for example, LAN, cable, etc., and wireless networks, such as WLAN, cellular, or satellite. The I/O interface (109) may include one or more ports for connecting a number of devices to one another or to another server. The memory (108) may be coupled to the processor (106). The memory (108) can include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard 15 disks, optical disks, and magnetic tapes. The memory (108) also includes a cache memory to work with the processing system (105) more effectively. Further, the processing system (105) includes the modules (111). The modules (111) include routines, programs, objects, components, data structures, etc., which perform tasks or implement particular abstract data types. In one implementation, the module (111) includes an analyzer module (112), score provider module (113), and other modules (111). The other modules (111) may include programs or coded instructions that supplement applications and functions of the processing system (105).

In one embodiment of the present invention, a method includes: providing an option to user “change Location” to change but not limited to the area, venue/hangout places, city & country. The User has to register, get a login and start talking to people nearby the user in his area and also anywhere in the world using the unique features VTP.

In one embodiment of the present invention, the customized character detection module is presented. This customized character detection module is a score based detection system. Score increases or decreases based on user interactions with other members every time chat sessions are closed. Members are separately color coded and changed accordingly based on the interaction with other users. The analyzer module is configured to analyze and award the colours based on to all the users based on their score & interactions, and this will change accordingly over a period of time. This is combined with the character detection system. This provides the users always an upper hand before starting a conversation

In one embodiment of the present invention, the processor is configured to receive the inputs from analyzer module and score detection module and further to transfer to the display device.

In one embodiment of the present invention provides a search feature where a user can search by profile or he can search by profession, or the user can search by the nativity of the others users or the user can search in accordance with the interest or search by contacts.

In one of the embodiments, the talent pool is presented where the members get to upload their work for free and the admins will select top 5 best works for the day and place it in the trending/editor's choice category.

In one of the embodiments, newsroom where the paid articles related to politics, education, entertainment & sports is presented in the virtual world networking application. In the politicssection, the latest paid articles are published and the live updates of the trend during election time. For the education section, the latest paid articles, providing syllabus related details, live updates of corporate companies with the job opportunities during campus college hiring. For the entertainment section, the latest paid articles, providing live opinions, reviews of latest releases. In sports section publishing of latest paid articles and providing live scores.

In one of the embodiments, trending now helps admins hand-pick the most trending topics and place them on the virtual world networking application. The user's talent/work is also displayed on the virtual networking application in the present invention.

In one of the embodiments, the editor's choice section provides a mixture of all news covered from all of our categories under differ rent related sections and are presented in the virtual world networking application.

In one of the embodiments, a refresh corners provided which is a one-stop solution for all like minded users. There will be chat rooms based on different categories. So, the members of the said networking application can decide by their choice of liking.

In one of the embodiments, an emergencies services are presented on the virtual world networking application where tie-up with volunteers, comprising members and essential services to help chosen emergency. This will be area specific and members in an emergency can send out an SOS message which will be flashed to the volunteers.

In an embodiment of the said invention, a messenger is provided which allows users to send messages to members using this application.

In one of the embodiments, an invite mode is provided in the virtual networking application.

The said mode will be visible in the chat messenger window where an invite to the table, invite to chill, invite for a coffee, invite to lunch/dinner, invite to date is provided to the users.

In one of the embodiments, a calling option which will be based on users permission is provided in the said virtual world networking application.

In one of the embodiments, a business option is provided. The human resources (HR) category in the said business option is tabled where an option of resume to be upload feature, Live screening of candidates resumes & discussions only with mutual consent, an instant short listing of candidates feature is provided on the said networking application. This reduces the time by more than half for hiring by removing multiple layers of entities & activities between employers & employees. Also, it finds most suitable candidates for particular job positions & hence, hugely reduces the dependency on HR firms.

In an exemplarily embodiment 200 of the present invention, describes the method steps of a Virtual World Processing System and Method Thereof. Following are the steps:
Step 1. providing a user an operable display on the handheld wireless device (201).
Step 2. allowing the user to selectively operate the hand-held wireless device by login (202).
Step 3. teleporting the user to be virtually present at multiple locations in a virtual world by virtual teleportation while being present at one physical location (203).
Step 4. enabling the user to communicate with multiple users nearby or worldwide when teleported with one or more characteristics at the same time (204).
Step 5. providing scores to the users based on color codes for character detection (205).
Step 6. analyzing the scores by a processing system (206).

A Privacy & Policies facility is also provided to the users. The users will have full control over every parameter in their profile under the settings section. There will be a full Admin Support 24/7. The emergency services, Tie up with volunteers comprising members and essential services to help chosen emergency situation. This will be area specific and members in an emergency situation can send out an SOS message which will be flashed to these volunteers. The Admin support team can ban users at any given point if they are violating the rules and regulation of the app. Users can ban or urban other users as per their likings. All the users of the said networking application will have different color codes based on their score & interactions, and this will change accordingly over a period of time/number of interactions with other members. While this is combined with the character detection system of the present virtual world networking application where users will always have the upper hand before starting a conversation

Although the disclosure has been provided with reference to specific exemplary embodiments, it will be evident that the various modification and changes can be made to these embodiments without departing from the broader spirit as set forth in the claims. Accordingly, the specification and drawings are to be regarded in an illustrative sense rather than in a restrictive sense.

Therefore, the following is claimed:

1. A method comprising:
providing a user an operable display on the handheld wireless device;
allowing the user to selectively operate the hand-held wireless device by login;
teleporting the user to be virtually present at multiple locations in a virtual world by virtual teleportation while being present at one physical location;
enabling the user to communicate with multiple users nearby or worldwide when teleported with one or more characteristics at the same time;
providing scores to the users based on color codes for character detection;
analyzing the scores by a processing system, and
providing users an upper hand before starting the communication.

2. The method as claimed in claim 1, wherein the said display showing one or more characteristics for the user to start communication with the multiple users and members.

3. The method as claimed in claim 2, wherein changing, area, venue/hangout places, city & country by change location characteristics.

4. The method as claimed in claim in claim 2, wherein increasing/decreasing scores, based on the user interactions with the members every time the communication session is closed.

5. The method as claimed in claim 4, wherein the members are separately color coded and changing accordingly based on their score and interactions, and changing accordingly over a period of time.

6. The method as claimed in claim 2, wherein searching the multiple users according to profile, profession, nativity, interest, and by contacts by search characteristics.

7. The method as claimed in claim 2, wherein uploading work by a talent characteristics, said work uploading by the members.

8. The method as claimed in claim 8, wherein selecting top best 5 works of the entire day and placing it in trending/editor's choice category.

9. The method as claimed in claim 2, wherein displaying paid articles by newsroom characteristics.

10. The method as claimed in claim 2, wherein displaying most trending topics placed by admins by trending now characteristics.

11. The method as claimed in claim 2, wherein the displaying mixture of news under different related sections by editor's choice characteristics.

12. The method as claimed in claim 2, wherein chatting based on members liking by refresh corner characteristics.

13. The method as claimed in claim 13, wherein the liking based on the different categorized chat rooms.

14. The method as claimed in claim 2, wherein providing emergency services to the members by emergency services characteristics.

15. The method as claimed in claim 15, wherein the members sending SOS message as emergency services flashing on volunteers device.

16. The method as claimed in claim 2, wherein allowing the multiple users to send messages to the members by chat messenger characteristics.

17. The method as claimed in claim 17, wherein invite mode visible on the chat messenger window to inviting members.

18. The method as claimed in claim 2, wherein calling based on the user permission by calling option characteristics.

19. The method as claimed in claim 2, wherein the displaying a human resources category by business section characteristics.

20. The method as claimed in claim 2, wherein the business section comprising resume uploading, live streaming of candidates resume and discussion only with mutual consent, and instant short listing of a candidate like services.
